(19) United States
(12) Patent Application Publication
(10) Pub. No.: US 2024/0390200 A1
(43) Pub. Date: Nov. 28, 2024

(54) ARTICULATING SEATING SYSTEM WITH INTEGRATED LIFTING DEVICE

(71) Applicant: The Braun Corporation, Winamac (IN)

(72) Inventors: Timothy G. Schwarz, Delafield, WI (US); Vernon Henry Rye, Mount Carmel, IL (US); Larry Dean Michels, Olney, IL (US); Erich Dwenger, Fishers, IN (US); Kevin Frayne, Noblesville, IN (US); Phillip Bell, Battle Ground, IN (US)

(21) Appl. No.: 18/772,125

(22) Filed: Jul. 13, 2024

Related U.S. Application Data
(63) Continuation of application No. PCT/US2024/031200, filed on May 27, 2024.
(60) Provisional application No. 63/651,297, filed on May 23, 2024.
(60) Provisional application No. 63/504,297, filed on May 25, 2023.

(51) Int. Cl. A61G 3/06; B60N 2/02; B60N 2/14

(52) U.S. Cl. CPC A61G 3/062; B60N 2/0256; B60N 2/14

(57) ABSTRACT

An integrated lifting device that is assembled with a seating system in a vehicle. The integrated lifting device includes a personal mobile device receiving portion configured to receive a personal mobile device and a user having limited mobility. The seating system can include a user seat for the user to transfer from a wheelchair, etc., to the user seat in the vehicle. A second seating system can be positioned adjacent the first seating system to receive the user. The personal mobile device receiving portion receives the wheelchair and transports the wheelchair into the vehicle. Alternative to the integrated lifting device, a hoist platform and hoist assembly can lift the wheelchair and user into the vehicle. The vehicle can include logic for the coordination of the movements of the wheelchair lifting device and the seating system.

### CROSS-REFERENCE TO OTHER APPLICATIONS

This application is a continuation of International Patent Application No. PCT/US24/31200, filed on May 27, 2024, which claims priority to U.S. Provisional Patent Application Nos. 63/504,297, filed on May 25, 2023, and 63/651,297, filed on May 23, 2024, the contents of which are incorporated herein by reference.

### FIELD OF THE DISCLOSURE

The present disclosure relates generally to a passenger vehicle that has been modified to allow access by a physically limited passenger, and more particularly to different techniques for moving a personal mobile device into the passenger vehicle. In some embodiments, a swivel seat base is used to move the personal mobile device into the passenger vehicle. In some embodiments, the sequencing of the transport of the passenger and their personal mobile device is described.

### BACKGROUND

Motor vehicles can have seats, seating assemblies, seating structures, etc. (referred to collectively at times herein as “seating systems”) either originally installed or retrofitted to address mobility and other issues for drivers and passengers. Some of these seating systems are manual (i.e., operated by the seat occupant or another person without powered assistance) and some are powered in the sense that one or more electric motors, actuators and/or the like are used to move one or more components of a given seating system. Swivel seat bases previously used to assist individuals with ingress and egress, have not addressed stowage and/or securement of personal mobility devices such as wheelchairs, powerchairs, scooters or walkers.

One of these seating systems includes three sub-systems or members that work together to allow forward linear movement and outward rotation of a user seat for an occupant and rearward linear movement during inward rotation of the user seat with the occupant. Users of these seating systems often have a personal mobile device (PMD) that assists them to the motor vehicle. Some users transfer from their PMD to the user seat and their PMD is stored in the motor vehicle to ride along with the user for use thereof after the user arrives at their destination.

Other motor vehicles have PMD ramps installed or retrofitted to address mobility and other issues for drivers and passengers. During operation, the PMD ramp extends from the vehicle to receive the user and their PMD and transfer the user and their PMD into the vehicle. As such, the user remains in their PMD while traveling in the vehicle that is fitted with the PMD ramp.

Many autonomous vehicles are electric and powered by a battery that is often positioned in a middle portion of the vehicle. This location of the battery conflicts with the location required for the PMD ramp in the vehicle. Moreover, many of these autonomous vehicles are not large enough to fit the user in the PMD on the PMD ramp inside the vehicle. Many vehicles have limited side entry space based on the location of the structure of the vehicle. This further restricts the size of the seating system and/or ramp.

Therefore, further contributions in this area of technology are needed to improve storage of the PMD in autonomous vehicles.

### SUMMARY OF THE EMBODIMENTS

In a first aspect of the present disclosure, an integrated lifting device for assembly with a seating system assembled with a vehicle, the integrated lifting device comprising: a personal mobile device receiving portion configured to receive a personal mobile device, the personal mobile device receiving portion configured for assembly or attachment to the seating system.

In some embodiments, wherein the personal mobile device receiving portion has a rectangular shape.

In some embodiments, wherein the personal mobile device receiving portion has one of these shapes: square, semi-circular, trapezoidal, or some combination of these geometric shapes.

In some embodiments, wherein the personal mobile device receiving portion is made of a material that is strong enough to support the personal mobile device.

In some embodiments, wherein the personal mobile device receiving portion has a thickness sufficient to support the personal mobile device.

In some embodiments, wherein the seating system is an articulated seating system.

In some embodiments, wherein the seating system includes a user seat.

In some embodiments, wherein the seating system is movable between an extension position and a drive position.

In some embodiments, wherein the personal mobile device receiving portion is movable between an extension position and a drive position.

In some embodiments, wherein the personal mobile device receiving portion is mounted or attached to any one of a front, a side, or a back of the seating system.

In some embodiments, wherein the personal mobile device receiving portion is positioned in one of a forward position of the seating system, a side position of the seating system, or rearward position of the seating system.

In some embodiments, wherein the personal mobile device receiving portion is sized to receive the personal mobile device that is any of a wheelchair, two or more wheelchairs, a manual wheelchair, a powerchair, a scooter, or a manual folding wheelchair.

In some embodiments, wherein the personal mobile device receiving portion includes an extension end opposite an attachment end with a body portion that spans between the extension and attachment ends.

In some embodiments, wherein the personal mobile device receiving portion includes an extension end having a width that is sufficient to receive the personal mobile device.

In some embodiments, wherein the personal mobile device receiving portion includes a body portion having a length and a width that are sufficient to receive the personal mobile device.

In some embodiments, wherein the personal mobile device receiving portion includes a body portion having a top surface configured to receive one or more devices to receive, secure, and restrain the personal mobile device.

In some embodiments, wherein the one or more devices include any of a securement strap, a docking system for a wheelchair, a bracket, a hold down bar, one or more wheel chocks, a cargo barrier, or one or more fasteners or bolts.

In some embodiments, wherein the personal mobile device receiving portion is integrated onto the seating system to support and transport the personal mobility device from an interior space of a vehicle to exterior of the vehicle, and vice versa.

In some embodiments, wherein the personal mobile device receiving portion is integrated onto the seating system to support and transport the personal mobility device from an interior space of a vehicle through a door opening of the vehicle to exterior of the vehicle, or vice versa.

In some embodiments, wherein the personal mobile device receiving portion is configured to move between an expanded configuration and a compact configuration.

In some embodiments, wherein the personal mobile device receiving portion is configured to fold one or more portions of itself for storage.

In some embodiments, wherein the personal mobile device receiving portion includes one or more sections configured to bend to decrease the size of the personal mobile device.

In some embodiments, wherein the seating system is mounted in a mid-right position of the vehicle relative to a door opening of the vehicle, and the personal mobile device receiving portion is assembled with the seating system in a front mount position or a side mount position relative to the door opening of the vehicle.

In some embodiments, wherein the seating system is mounted in a front mounting position relative to a door opening of the vehicle; and wherein the personal mobile device receiving portion is adequately sized and positioned in front of the seating system such that the seating system and the personal mobile device receiving portion are configured to move together through the door opening of the vehicle.

In some embodiments, wherein the vehicle is an autonomous vehicle.

In some embodiments, wherein the seating system is mounted in a side mounting position relative to a door opening of the vehicle; and wherein the personal mobile device receiving portion is positioned adjacent the seating system.

In some embodiments, wherein the personal mobile device receiving portion includes an attachment end that is configured for assembly with the seating system.

In some embodiments, wherein the attachment end includes one or more openings sized to receive one or more fasteners for assembly with the seating system.

In some embodiments, wherein the attachment end is welded to the seating system.

In some embodiments, wherein the attachment end includes one or more sliding mechanisms for assembly with one or more members of the seating system to lock the attachment end to the seating system.

In some embodiments, wherein the personal mobile device receiving portion travels with the seating system, such that when the seating system is deployed outside of the vehicle, the personal mobile device receiving portion is level on the ground in an access position allowing the personal mobile device to be maneuvered onto the personal mobile device receiving portion.

In another aspect of the present disclosure, an integrated lifting device for assembly with a vehicle, the integrated lifting device comprising: a personal mobile device receiving portion configured to receive a personal mobile device, the personal mobile device receiving portion configured for assembly or attachment to a first seating system assembled with the vehicle, wherein a second seating system is positioned adjacent the first seating system.

In some embodiments, wherein the first and second seating systems are each an articulated seating system.

In some embodiments, wherein the vehicle is an autonomous vehicle.

In some embodiments, wherein the personal mobile device receiving portion and the first seating system are positioned in a first row of the vehicle and the second seating system including a user seat is positioned in a second row of the vehicle, wherein a vehicle opening of the vehicle is configured to receive the first and second seating systems, the personal mobile device receiving portion, and the user seat.

In some embodiments, wherein the personal mobile device receiving portion and the first seating system are positioned in a second row of the vehicle and the second seating system including a user seat is positioned in a third row of the vehicle, wherein a vehicle opening of the vehicle is configured to receive the first and second seating systems, the personal mobile device receiving portion, and the user seat.

In some embodiments, wherein the personal mobile device receiving portion and the first seating system are positioned in a second row of the vehicle and the second seating system including a user seat is positioned in a third row of the vehicle, wherein a vehicle opening of the vehicle is configured to receive the first and second seating systems, the personal mobile device receiving portion, and the user seat.

In some embodiments, wherein the personal mobile device receiving portion and the first seating system are positioned in one row of the vehicle and the second seating system including a user seat is positioned in the one row of the vehicle adjacent the first seating system.

In some embodiments, wherein the vehicle can be a van, an autonomous vehicle, or another type of vehicle.

In some embodiments, wherein the personal mobile device receiving portion is assembled with the second seating system instead of the first seating system.

In some embodiments, wherein the first and the second seating systems with the personal mobile device receiving portion deploy together.

In some embodiments, wherein the first and the second seating systems with the personal mobile device receiving portion deploy independently of each other.

In some embodiments, wherein the first and the second seating systems with the personal mobile device receiving portion are moved from a secured drive position to an extension position wherein the first and the second seating systems with the personal mobile device receiving portion extend through a vehicle opening of the vehicle.

In some embodiments, wherein the first and the second seating systems with the personal mobile device receiving portion move from a drive position to an access position that is outside the vehicle.

In some embodiments, wherein the personal mobile device receiving portion supports and transports a personal mobile device with or without an occupant from outside of the vehicle to inside the vehicle.

In some embodiments, wherein the personal mobile device receiving portion is configured to stow or store the personable mobile device.

In some embodiments, wherein the first seating system being deployed outside of the vehicle, the personal mobile device receiving portion is substantially level on the ground in an access position to receive a personal mobile device thereon.

In some embodiments, wherein the first and second seating systems travel from an access position that is outside of the vehicle to a drive position that is inside of the vehicle.

In another aspect, an apparatus for moving a personal mobile device into a vehicle, the apparatus comprising: a hoist platform positioned adjacent a seating system mounted in the vehicle, the hoist platform configured to receive a personal mobile device; and a lifting mechanism assembled with the hoist platform, wherein the lifting mechanism is configured to move the hoist platform and the personal mobile device between an interior of the vehicle and an exterior of the vehicle.

In some embodiments, wherein the hoist platform is configured to stow the personal mobile device.

In some embodiments, wherein the hoist platform has any one of these shapes including a rectangle, a square, a semi-circular, a trapezoid, or some combination of these geometric shapes.

In some embodiments, wherein the hoist platform is made of a material that can support the personal mobile device.

In some embodiments, wherein the hoist platform includes a body portion that spans between an extension end and an attachment end.

In some embodiments, wherein the body portion includes a top surface that is configured with one or more devices to secure the personal mobile device in place while the vehicle is in motion.

In some embodiments, wherein the one or more devices include any of a securement strap, a docking system, a bracket, a hold down bar, one or more wheel chocks, a cargo barrier, one or more fasteners, and/or one or more bolts.

In some embodiments, wherein the attachment end is configured for assembly with the lifting mechanism.

In some embodiments, wherein the attachment end includes one or more openings sized to receive one or more fasteners for assembly with the lifting mechanism.

In some embodiments, wherein the attachment end is welded to the lifting mechanism

In some embodiments, wherein the attachment end is assembled with the lifting mechanism by one or more sliding mechanisms that allow interlocking between the attachment end and one or more members of the lifting mechanism.

In some embodiments, wherein the lifting mechanism assembled with the hoist platform is positioned in a first row of the vehicle and the seating system including a user seat is positioned in a second row of the vehicle, wherein a vehicle opening of the vehicle is configured to receive the hoist platform, the seating system, and the user seat.

In some embodiments, wherein the lifting mechanism assembled with the hoist platform is positioned in a second row of the vehicle and the seating system including a user seat is positioned in a third row of the vehicle, wherein a vehicle opening of the vehicle is configured to receive the hoist platform, the seating system, and the user seat.

In some embodiments, wherein the vehicle is any of a van, an autonomous vehicle, or another type of vehicle.

In some embodiments, wherein the seating system and the hoist platform deploy together.

In some embodiments, wherein the seating system and the hoist platform deploy independently of each other.

In some embodiments, the sequencing of moving independent systems is considered. In some vehicle configurations, the entry of the accessible vehicle may not be adequate to fit both the seating system and the PMD lift while they are transferring from the stowed to the deployed positions at the same time. In this case, sequencing of the operations of the seating system and PMD lift must be set to prevent any contact either between the two systems, or with the vehicle. Such contact could damage the vehicle, the systems, or cause safety concerns for the passenger.

In some embodiments, the individual systems may additionally be positioned as to not block the entry for ambulatory passengers when inside the vehicle. They will need to be transferred fore and aft inside the vehicle. This step of movement is considered in the sequencing of the movement.

In some embodiments, the seating system and the hoist platform move from a drive position to an access position that is outside the vehicle. In some embodiments, the hoist platform is configured to stow or store the personal mobile device.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIGS. 1A-1F are plan views of one or more implementations of a vehicle access seating system.

FIG. 1G is an isometric view of one or more embodiments of an articulated seating system.

FIGS. 2A-2D are various views of one or more implementations of a vehicle access seating system in different positions during extension and retraction of the user seat to permit occupant egress and ingress in a motor vehicle.

FIG. 3A is a side view of one implementation of an integrated platform assembled with the articulated seating system of FIG. 1G in an access position.

FIG. 3B is a side view of the integrated platform of FIG. 3A with a PMD resting on the integrated platform.

FIG. 3C is a side view of the integrated platform of FIG. 3A assembled with the articulated seating system of FIG. 1G in a drive position.

FIG. 4A is a side view of one implementation of an integrated platform assembled with the articulated seating system of FIG. 1G and one implementation of the articulated seating system of FIG. 1G wherein both implementations are in a drive position.

FIG. 4B is a side view of the two implementations of FIG. 4A wherein both implementations are in an access position.

FIG. 5 is a side view of a hoist platform and one implementation of the articulated seating system of FIG. 1G wherein the hoist platform and the implementation are in an access position.

FIG. 6 is an example of logic to provide steps for a passenger entering the accessible vehicle with a narrow entry point using the PMD lift and seating system that cannot fit through the entry simultaneously.

FIG. 7. Is an example of logic to provide steps for a passenger exiting the accessible vehicle with a narrow entry point using the PMD lift and seating system that cannot fit through the entry simultaneously.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

Vehicle access seating is the subject of U.S. Pat. No. 10,336,216, issued on Jul. 2, 2019, and U.S. Pat. No. 11,059,393, issued on Jul. 13, 2021, both of which are incorporated herein by reference in their entireties for all purposes. The vehicle access seating disclosed in these references are exemplary embodiments that can be assembled or used with the present disclosure.

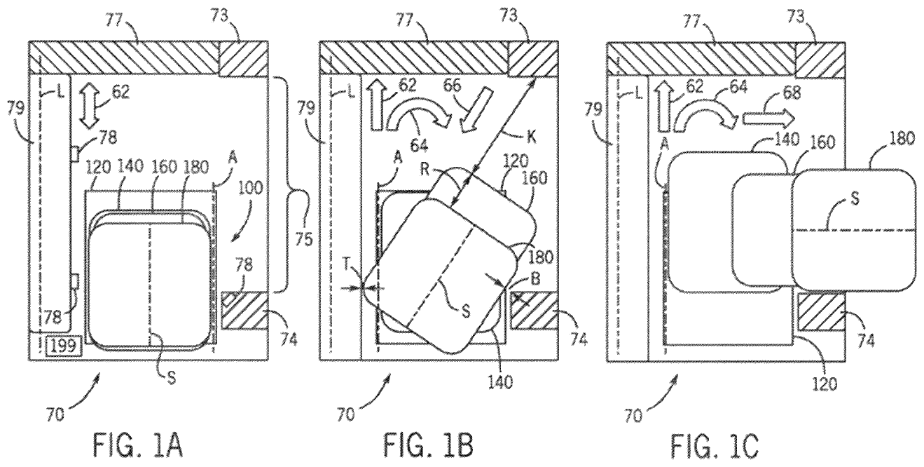

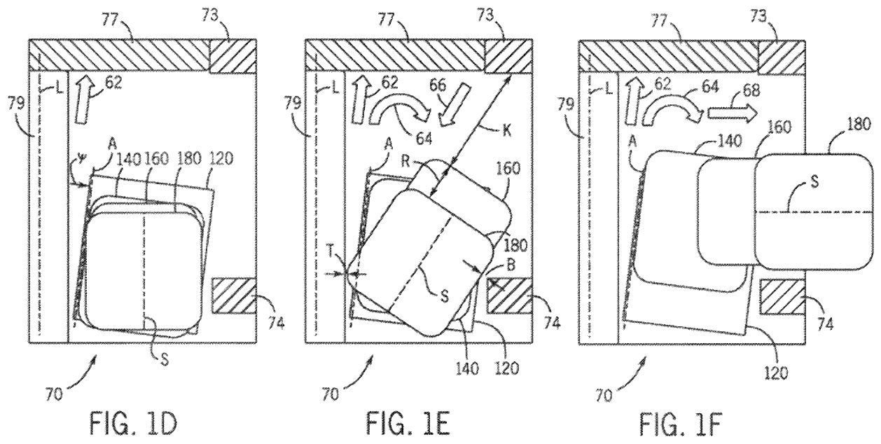

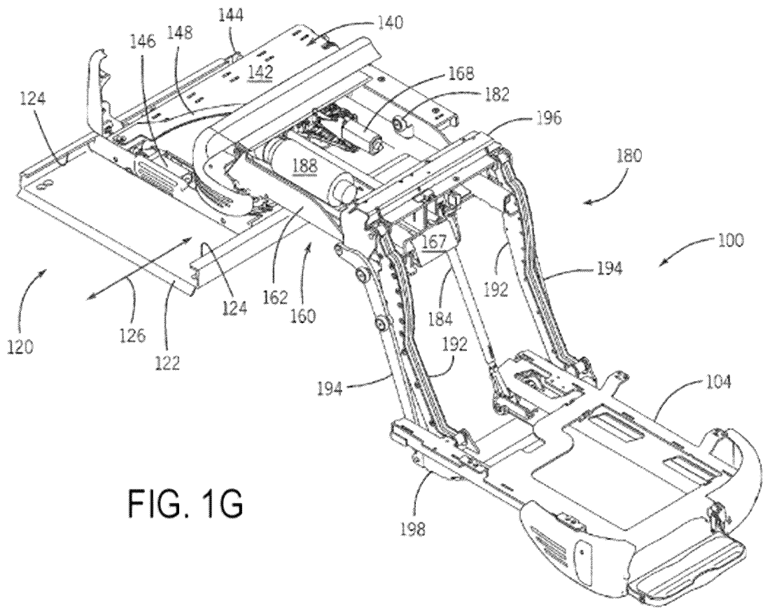

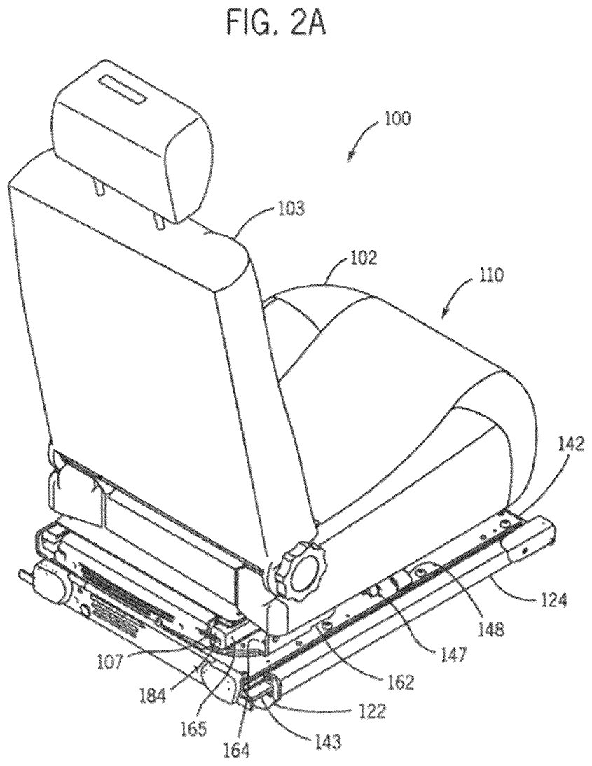

When installed in a motor vehicle 70, vehicle access seating implementations can be viewed as a “stack” of assemblies that can include, from lowermost to uppermost-a mounting assembly, a fore-aft slide assembly, a swivel assembly and an extension/retraction assembly (which includes the user seat unit)—illustrative examples are shown respectively as assemblies 120, 140, 160 and 180 in FIGS. 1A-1F. These assemblies can be operated by one or more motors or the like, and such motors coordinate movement of the user seat unit to increase legroom for a seat occupant by reducing or minimizing the clearance between the user seat and a motor vehicle B-pillar and by reducing or minimizing the clearance between the user seat and a motor vehicle centerline tunnel.

More particularly, vehicle access seating implementations providing improved occupant knee room (or legroom generally) that are shown generally in FIGS. 1A through 1F include a mounting assembly 120 (also referred to as an “adapter plate assembly”) configured to be secured to the interior of a motor vehicle 70 in approximately the same location and position as an OEM motor vehicle seat mounting (i.e., a motor vehicle internal seat position adjacent to a motor vehicle door).

In FIGS. 1A to 1C, the mounting assembly 120 is mounted generally parallel to the motor vehicle centerline (e.g., a centerline tunnel, if present) 79 and motor vehicle longitudinal axis L. Alternatively, in FIGS. 1D to 1F, the mounting assembly 120 is mounted at a horizontal offset (or “twist”) angle ω of ˜1° (±1° to the motor vehicle centerline 79 and vehicle axis L. In some situations, this horizontal angular offset W of one or more of the lower assemblies of the seating system 100 allows the footprint of system 100 to better match the floor space in motor vehicle 70. In some implementations the seating system 100 can be −900 mm long, meaning that a 1° turn of the system's base creates 16 mm of additional space on the sides. Moreover, the 1° offset can be nominal and long mounting holes in some brackets of the seating system 100 implementations may allow for an additional 1° of twist (i.e., 2° total), meaning that installation of the system 100 can actually provide closer to 32 mm or approximately 1.25 inches of extra space, thus allowing for installation in a wider variety of motor vehicles including autonomous vehicles.

A first slide assembly 140 (also referred to as a “fore-aft slide assembly”) is configured to move linearly relative to the adapter plate in parallel with the adapter plate longitudinal axis A and relative to the mounting assembly 120 (per arrow 62 in FIGS. 1A-1F). This first linear motion slides the seat's pivot mechanism into position to begin seat rotation away from the vehicle's centerline 79 and toward the vehicle door 75 (between the A-pillar 73 and the B-pillar 74). A swivel assembly 160 has a swivel post that engages the fore-aft slide assembly 140 and controls rotation of the user seat relative to adapter plate axis A to pivot the seat around the B-pillar 74 (per arrow 64 in FIGS. 1A-1F). While the seat rotates, a second slide assembly 180 (also referred to as an “extension/retraction slide assembly”) slides the seat linearly (per arrows 66 and 68 in FIGS. 1B and 1E) parallel to the user seat's axis S (referred to herein as the “seat axis S”), which may have pivoted so that it is not parallel to adapter plate axis A. As seen in FIGS. 1B and 1E, as the extension/retraction slide assembly 180 retracts the seat 102 (i.e., away from dashboard 77 and A-pillar 73) during rotation (and possibly during fore-aft movement along axis A as well), the legroom or knee room for a seat occupant increases substantially.

In FIGS. 1A-1F, the fore-aft slide assembly 140, swivel assembly 160 and extension/retraction slide assembly 180 coordinate the user seat movement in some implementations to increase or maximize an occupant's knee room (i.e., the spacing between an occupant's legs and the motor vehicle dashboard 77 and A-pillar 73) by reducing the user seat clearance T (i.e., the clearance between the user seat unit and the centerline 79) and the user seat clearance B (i.e., the clearance between the user seat unit and the B-pillar 74). This second linear movement can, in some implementations, include retracting the seat “back” from its original position (i.e., away from the dashboard 77, A-pillar 73, and/or B-pillar 74) by a distance R, as seen in FIGS. 1B and 1E.

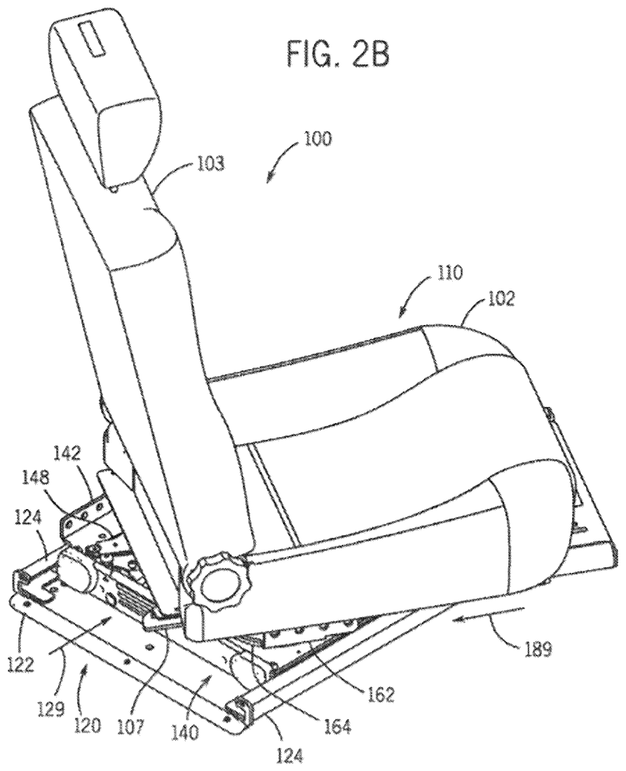

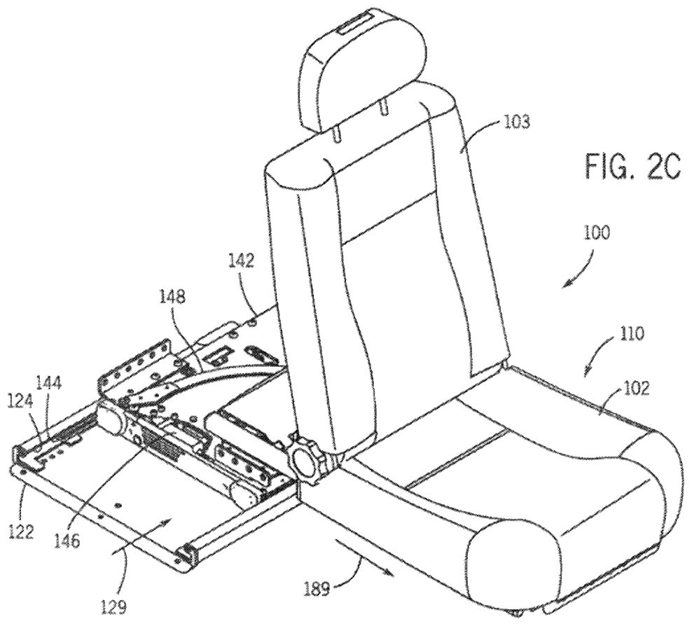

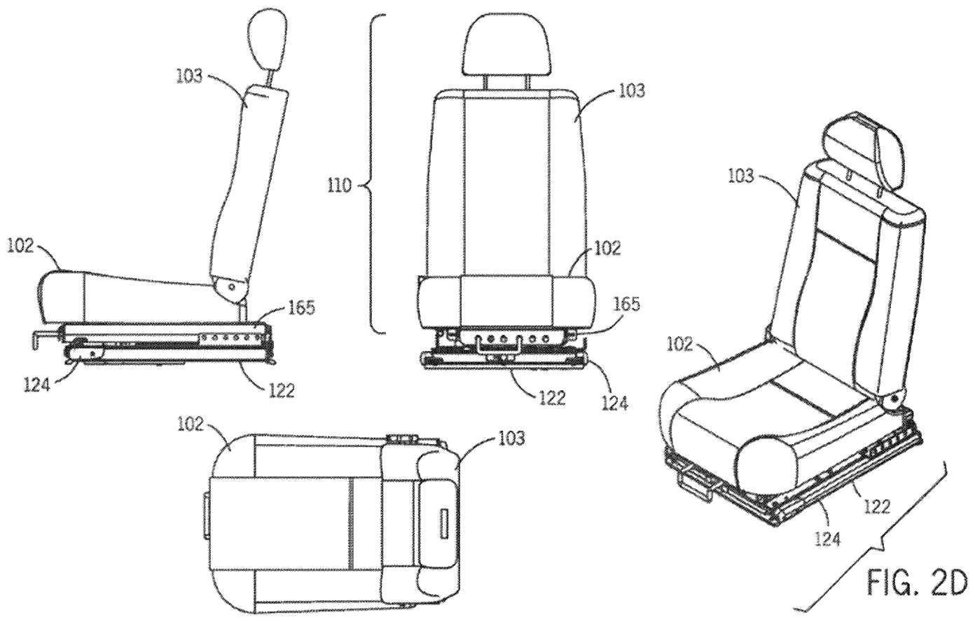

FIGS. 2A-2D illustrate a seating system 100 in various positions during its sequential operation including linear fore-aft movement parallel to static axis A as illustrated by arrow 129 and linear extension/retraction movement parallel to pivotable axis S as illustrated by arrow 189 in FIGS. 2B and 2C. Other components and movements (including rotation of the user seat unit 110) are discussed in more detail below. FIG. 2D shows the seating system 100 from several angles. The combination of multiple-axis linear movements and rotational movement permits multiple axis movement of the user seat. In each implementation of the seating system 100, the user seat moves through a transition corridor defined in the motor vehicle interior.

Stated another way, according to one or more implementations the user seat is moved from the drive position to the access position by coordinating the following movements of the seat: (1) linear movement along a first axis that is static relative to an adapter plate mounted within the motor vehicle (e.g., adapter plate axis A, as discussed in more detail herein); (2) rotating the seat relative to the static (first) axis; and (3) linear movement along a second axis that is pivotable, the second axis's orientation depending upon the amount of seat rotation (e.g., seat axis S, as discussed in more detail herein). During movement of the seat from between the drive position and the access position, occupant legroom can be increased by reducing or minimizing the clearance between the user seat and a motor vehicle B-pillar and by reducing or minimizing the clearance between the user seat and a motor vehicle centerline 79.

FIGS. 1A-1F and 2A-2D illustrate one or more implementations of an articulated seating system 100. Some such implementations can be viewed as a number of assemblies supporting a user seat unit 110 that can include a chair plate, seat pan and/or seat bracket 104 and associated mounted user seat cushion 102 (to which a backrest 103 and optional headrest may be mounted, if desired). The multiple assemblies can include a mounting assembly 120, a fore-aft slide assembly 140, a swivel assembly 160, and an extension/retraction slide assembly 180, where the assemblies work cooperatively to provide multiple-axis rotation and movement of the user seat unit 110. These various assemblies are driven and/or powered in some implementations by a drive packet that includes one or more motors, engines, actuators or the like for causing components, assemblies, etc. to move relative to one another. In some implementations, the swivel assembly 160 and extension/retraction assembly 180 operate in conjunction with the fore-aft slide assembly 140, combining two linear motions with rotation to maintain the user seat within predetermined thresholds with respect to (1) clearance T, the distance between the seat unit 110 and the motor vehicle centerline 79, and (2) clearance B, the distance between the seat unit 110 and the motor vehicle's B-pillar, both shown in FIGS. 1B and 1E, and thus providing substantial relative knee room for an occupant of the user seat during both egress from and ingress into the motor vehicle 70. One component of the occupant knee room is clearance K, seen in FIGS. 1B and 1E, which is the distance between the front edge of the swivel assembly 160 and a forward internal motor vehicle structure (e.g., either dashboard 77 or A-pillar 73 in FIGS. 1B and 1E). Because the extension/retraction assembly 180 allows seat 102 to retract away from the dashboard 77 and A-pillar 73 (retraction distance R in FIG. 1B), the total knee room for an occupant of seat 102 is the clearance K+R.

As noted, two types of linear motion are used in various vehicle access seat implementations. The first type of linear motion is linear motion of the first slide assembly parallel to static axis A and relative to the mounting assembly 120. The second type of linear motion is linear motion of the second slide assembly relative to the swivel assembly 160 and parallel to pivotable axis S (i.e., if the user seat 102 has rotated 90° from the adapter plate axis A, then the second type of linear motion will be on a line parallel to axis S, 90° off of axis A). Using a combination of these linear motions with rotation of the user seat unit 110 (such combinations can utilize sequential incremental movements and/or simultaneous movements of two or more of these), the user seat centerline clearance T and the user seat B-pillar clearance B can be minimized and/or maintained within specified thresholds until user seat 102 can be extended past the B-pillar to an access position in which seat 102 extends at least partially outside the door 75 of the motor vehicle 70. When this combination of motions is used, the user seat total clearance K+R is increased and, in some implementations, maximized. In addition to providing better comfort and use for an occupant of the seat 102, this also provides an improved clearance of the door 75 situated between the motor vehicle A-pillar and the B-pillar.

Articulated seating system is the subject of U.S. Pat. No. 9,415,703, issued on Aug. 16, 2016, and U.S. Pat. No. 8,936,295, issued on Jan. 20, 2015, both of which are incorporated herein by reference in their entireties for all purposes. The articulated seating systems disclosed in these references are exemplary embodiments that can be assembled or used with the present disclosure. FIG. 1G correlates to FIG. 1 from the articulated seating system illustrated and described in U.S. Pat. No. 9,415,703, and is included in the present application for description of an exemplary articulated seating system. Other articulated seating systems can be used with the present application.

The Figures in U.S. Pat. No. 9,415,703, illustrate one or more embodiments of an articulated seating system 100. Some such embodiments can be viewed as a number of assemblies supporting a seat bracket 104 and associated mounted user seat 102—e.g., a mounting assembly 120, a fore-aft slide assembly 140, a swivel assembly 160 and an extension assembly 180, which are driven and/or powered by a drive packet that can include one or more motors, engines, actuators or the like for causing components, assemblies, etc. to move relative to one another.

Fore-aft slide assembly 140 is configured to move user seat 102 linearly forward and backward relative to the mounting assembly 120 and relative to the front and back of a motor vehicle 70 in which system 100 is mounted. As explained in more detail below and illustrated in one or more of the Figures, some embodiments use a slider mechanism to enable this fore-aft slide assembly 140 movement.

Swivel assembly 160 is configured to rotate user seat 102 relative to the fore-aft slide assembly 140 in some embodiments, rotating user seat 102 (using incremental or continuous motion) between 90° and 180° relative to the direction of linear fore and aft movement (shown in FIG. 1 as arrow 126), and in some embodiments rotating user seat 102 about 105° to 115°. In some embodiments the swivel assembly 160 works in concert with the fore-aft slide assembly 140 and/or the extension assembly 180 (e.g., through combined user seat movement by the fore-aft slide assembly 140 and the swivel assembly 160, or alternatively through combined user seat movement by the fore-aft slide assembly 140, the swivel assembly 160 and the extension assembly 180 in some embodiments) to permit movement of the user seat 102 through a “transition corridor” within a motor vehicle from a “drive position” inside the motor vehicle (in some embodiments the drive position allows the occupant of articulated seating system 100 to be the motor vehicle's driver) to an “extension position” where the user seat 102 is positioned so that it can be extended outwardly (i.e., to the exterior of a motor vehicle) to an “access position” outside the motor vehicle (including embodiments where such movement from the drive position to the extension position through the transition corridor can be performed within a motor vehicle that has a transition corridor that is less than 20 inches and, in some embodiments is as small as 18 inches or less), embodiments of which are explained in more detail below.

The extension assembly 180 is configured to move a user seat 102 mounted as part of articulated seating system 100 between the extension position, in which the user seat 102 may be at least partially inside the motor vehicle, and the access position outside the motor vehicle, which typically is vertically lower than the drive position or is arrived at using vertical movement of the user seat 102 during movement between the extension position and the access position (although the access position's vertical height can be at the same vertical level or higher, if desired, by configuring the underside channel 185 in each support arm 192, as described in more detail below).

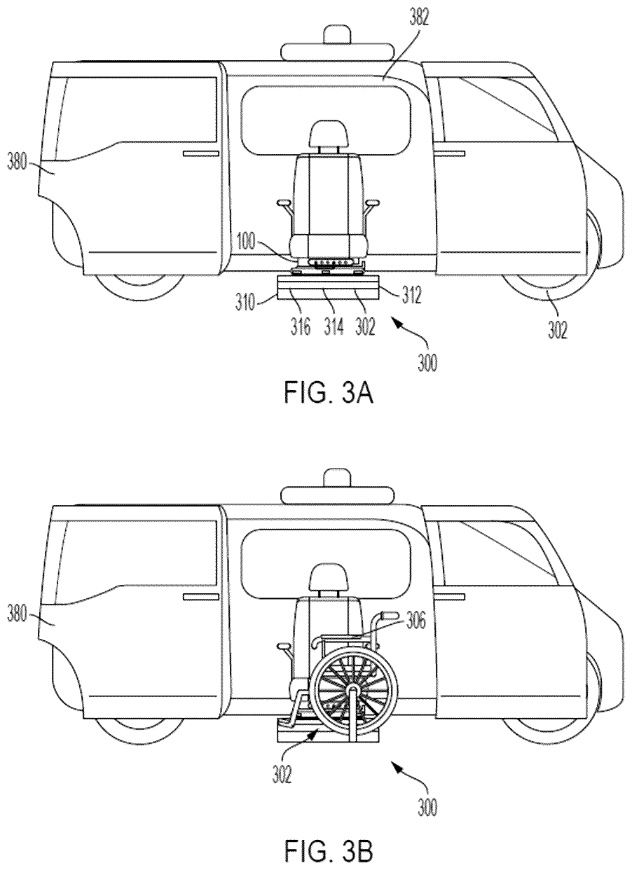

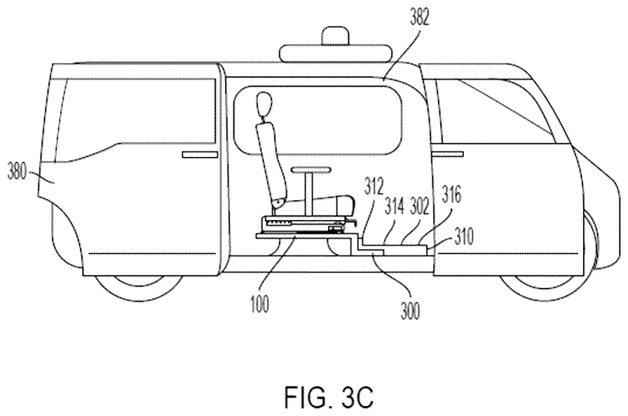

FIGS. 3A-3C illustrate one implementation of an integrated platform 300 assembled with the articulated seating system 100 of FIG. 1G. The articulated seating system 100 is designed to transfer an occupant from inside the vehicle to outside of the vehicle, or vice versa, with an extension or the integrated platform 300 integrated onto the articulated seating system 100 for the purpose of supporting and transporting a personal mobility device (PMD) 306 from inside a vehicle 380 to outside of the vehicle 380, or vice versa, all in the same sequence. As shown, the integrated extension or platform 300 may be a structure able to support the load of the PMD 306, including but not limited to a solid platform that supports the wheels of the PMD 306. In some embodiments, the integrated platform 300 is configured to fold one or more portions of itself to be more compact for storage or transport. It is contemplated, however, that the integrated platform 300 may be substituted with connecting members that receive and/or engage with a portion of the PMD 306 to carry it into the vehicle, including but not limited to hooks, straps, clasps, claws, or other connecting members that receive and carry the PMD 306 in a folded state or in its usable (unfolded) state as shown.

The integrated platform 300 includes a personal mobile device (“PMD”) receiving portion 302 assembled or attached to the articulated seating system 100 of FIG. 1G. The integrated platform 300 can be mounted or attached to a front, a side, or a back of the articulated seating system 100. The integrated platform 300 can be positioned in front of, alongside, or behind the articulated seating system 100 or the seating system 100. The position of the integrated platform 300 can vary due to the type of the PMD being transported (size, weight, etc.), the seating systems such as articulated seating system 100 or seating system 100 positioned in the vehicle 380, a vehicle door opening size, type of vehicle doors, and other vehicle or seating systems. The PMD receiving portion 302 may be sized to receive a personal mobile device such as a wheelchair 306 as illustrated in FIG. 3B. The PMD receiving portion 302 can be sized to receive other types of personal mobile devices or multiple personal mobile devices. The PMD receiving portion 302 may be large to accommodate manual wheelchairs or powerchairs or the PMD receiving portion 302 can be small to accommodate manual folding wheelchairs.

In one exemplary embodiment, the articulated seating system 100 is mounted in a mid-right position of the vehicle 380 and the integrated platform 300 can be assembled with the articulated seating system 100 in a front mounting position, a side position, or a rear position. In a front mounting position, to transport a larger PMD such as a non-folding wheelchair, powerchair, or scooter, the integrated platform 300 is adequately sized and positioned in front of the articulated seating system 100, with the seating system 100 positioned aft in the vehicle 380 relative to the door opening 382. This orientation and configuration may be most effective. For this embodiment, a large door opening is needed such as a sliding door in the second row of a minivan. Alternatively, the door opening 382 of an autonomous vehicle may be large enough to accommodate the integrated platform 300 and the articulated seating system 100. Other types of vehicles and door openings may be used with the articulated seating system 100 with the integrated platform 300 mounted thereon.

In a first side mounting position, to transport a larger PMD such as a non-folding wheelchair, powerchair, or scooter, the integrated platform 300 is adequately sized and positioned alongside the articulated seating system 100. This orientation and configuration may be most effective. The side mounting position may require the removal of OEM seats that would otherwise be adjacent to the articulated seating system 100, that is now occupied by the integrated platform 300. For this application a large door opening is needed such as a sliding door in the second row of a minivan. Alternatively, the door opening 382 of an autonomous vehicle may be large enough to accommodate the integrated platform 300 and the articulated seating system 100.

In a second side mounting position, to transport a small PMD such as a folding wheelchair, walker, etc., the integrated platform 300 is adequately sized to accommodate the footprint of a folded wheelchair or folded walker. This orientation and configuration may be most effective. For this application, the removal of OEM seats that would otherwise be adjacent to the seating system may be needed. Alternatively, the door opening 382 of an autonomous vehicle may be large enough to accommodate the integrated platform 300 and the articulated seating system 100.

In the illustrated embodiment, the PMD receiving portion 302 is a rectangular shape with a width and a length. In other embodiments, the PMD receiving portion 302 is shaped differently such as square, semi-circular, trapezoidal, or some combination of these geometric shapes. The PMD receiving portion 302 is made of a material that is strong enough and/or has a depth or thickness that is sufficient to hold the PMD 306 thereon.

The PMD receiving portion 302 may include an extension end 310 opposite an attachment end 312 with a body portion 314 that spans between the extension and attachment ends 310 and 312, respectively. The extension end 310 may include a width that is sufficient to receive the PMD 306. The body portion 314 may have a length and a width that are sufficient to receive the PMD 306. The body portion 314 includes a top surface 316 that may be configured with one or more devices to receive, secure, and restrain the PMD 306 or other similar personal mobile devices in place while the vehicle 380 is in motion. For example, the one or more devices could include but is not limited to manual or automated securement such as securement straps, docking system for a wheelchair, bracket, hold down bar, wheel chocks, cargo barrier, fasteners, bolts, etc., that can be assembled on the body portion 314 to receive, secure, and restrain the PMD 306 in place while the vehicle 380 is in motion.

The attachment end 312 can be configured for assembly with the articulated seating system of FIG. 1G. The attachment end 312 can also be configured for assembly with the vehicle access seating system 100 of FIGS. 1A-1F or FIGS. 2A-2D, other types of vehicle access seating systems, or other types of articulated seating systems. In one embodiment, the attachment end 312 includes one or more openings sized to receive one or more fasteners for assembly with the articulated seating system of FIG. 1G. In another embodiment, the attachment end 312 is welded to the articulated seating system of FIG. 1G. In yet another embodiment, the attachment end 312 is assembled with the articulated seating system of FIG. 1G by one or more sliding mechanisms that allow interlocking between the attachment end 312 and one or more members of the articulated seating system. In other embodiments, the attachment end 312 is assembled with the articulated seating system of FIG. 1G by other techniques.

The integrated platform 300 supports and transports the PMD 306 from outside to inside the vehicle 380 and stows or stores the PMD 306 while the articulated seating system 100 or the seating system 100 are in its travel (home) or drive position and the vehicle 380 is in motion as illustrated in FIG. 3C (PMD 306 not illustrated). The integrated platform 300 travels with the articulated seating system 100, such that when the articulated seating system 100 is deployed outside of the vehicle 380, the integrated platform 300 is level on the ground in an access position allowing the PMD 306 to be maneuvered onto the integrated platform 300 and the occupant to transfer from the PMD 306 to the articulated seating system 100 as illustrated in FIG. 3B. The integrated platform 300 travels with the articulated seating system 100, such that when the articulated seating system 100 is deployed outside of the vehicle 380, persons with limited mobility can transfer to the articulated seating system 100, then independently or with help from an attendant, maneuver the PMD 306 to the integrated platform 300.

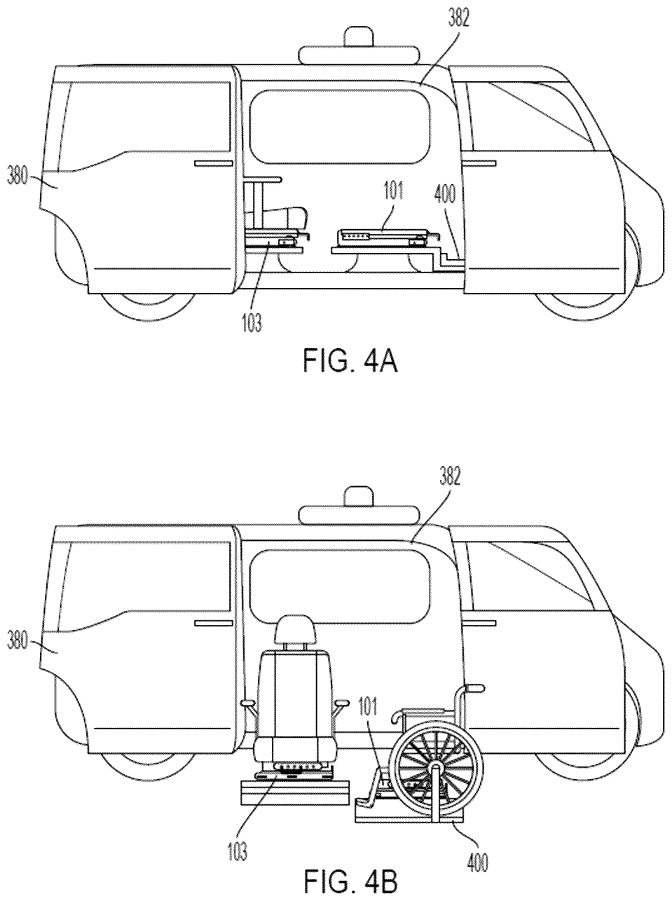

FIGS. 4A-4B illustrate another implementation of an integrated platform 400 assembled with a first of the articulated seating system 100 of FIG. 1G and a second of the articulated seating system 100 positioned adjacent the first articulated seating system 100. The first of the articulated seating system 100 is designated as first articulated seating system 101 in the FIGS. 4A-4B. The second articulated seating system 100 is designated as second articulated seating system 103 in the FIGS. 4A-4B. The integrated platform 400 is substantially similar to the integrated platform 300 therefore will not be described again. It is contemplated, however, that the integrated platform 400 may be substituted with straps, hooks, clasps, claws, or other connecting members that receive and hold the PMD 306.

In one embodiment, the first articulated seating system 101 with the integrated platform 400 attached thereon are positioned in the vehicle 380 in the first row and the second articulated seating system 103 with a user seat is positioned in the second row on the same side of the vehicle 380 wherein the vehicle opening 382 is configured to receive the first and second articulated seating systems 101 and 103, the integrated platform 400, and the user seat. In one embodiment, the vehicle 380 is an autonomous vehicle wherein the first and second articulated seating systems 101 and 103, respectively, are positioned and attached in the first and second rows of the vehicle 380 and both systems exit through the vehicle opening 382. As described above, the integrated platform 400 is attached to the first articulated seating system 101. The first articulated seating system may or may not (as shown) include a user seat. Although FIG. 4A depicts the integrated platform 400 being positioned forward of the articulated seating system 101 in the vehicle, it is contemplated that the first articulated seating system 101 could be rotated, including up to 180 degrees, whereby the platform 400 may be positioned to either side of the first articulated seating system 101 or between the first articulated seating system 101 and the second articulated seating system 103.

In another embodiment, the first articulated seating system 101 with the attached integrated platform 400 are positioned in the vehicle 380 in the second row and the second articulated seating system 103 with user seat is positioned in the third row on the same side of the vehicle 380. In this embodiment, both systems exit through the vehicle opening 382.

In yet other embodiments, the first articulated seating system 101 with the integrated platform 400 attached thereon and the second articulated seating system 103 with user seat are positioned in the same row and adjacent to each other. In this embodiment, the user in their PMD 306 can transfer or move onto the integrated platform 400 wherein the first articulated seating system 101, integrated platform 400, and user move into the vehicle 380. The user or occupant can then transfer to the user seat on the second articulated seating system 103.

In any of the embodiments, the vehicle 380 can be a van, an autonomous vehicle, or another type of vehicle configured to receive the first and the second articulated seating systems 101 and 103, the integrated platform 400, and the user seat, in any combination of rows and on either side of the vehicle. In other embodiments, the placement of the first and second articulated seating systems 101 and 103 can be reversed. In yet other embodiments, the integrated platform 400 is assembled with the second articulated seating system 103 instead of the first articulated seating system 101. In any embodiment, the user seat may be assembled with either the first or the second articulated seating systems 101 and 103, respectively, or both can include user seats, which may fold or otherwise stow when not in use.

In one method of operation, the first and the second articulated seating systems 101 and 103 with the integrated platform 400 and the user seat deploy next to each other either independently or together. The first and the second articulated seating systems 101 and 103 with the integrated platform 400 and the user seat are moved from a secured drive position (e.g., a standard interior vehicle seat position) to an extension position (wherein the first and the second articulated seating systems 101 and 103 with the integrated platform 400 and the user seat face out of the vehicle doorway or opening 382) and finally to an access position outside the vehicle 380, facilitating access for a user in the PMD 306. In one embodiment, the first articulated seating system 101 with the integrated platform 400 supports and transports the PMD 306 with or without the occupant from outside to inside the vehicle 380. The occupant of the PMD 306 can transfer to the user seat associated with the second integrated platform 103 before or after being positioned inside the vehicle 380. In another embodiment, the integrated platform 400 is attached to the second articulated seating system 103 and the user seat is attached to the first articulated seating system 101.

The integrated platform 400 stows or stores the PMD 306 while the first and the second articulated seating systems 101 and 103 are in their travel (home) or drive position and the vehicle 380 is in motion as illustrated in FIG. 4A (PMD 306 not illustrated). The integrated platform 400 travels with the first articulated seating system 101, such that when the first articulated seating system 101 is deployed outside of the vehicle 380, the integrated platform 400 is level on the ground in an access position allowing the PMD 306 to be maneuvered onto the integrated platform 400 and the occupant to transfer from the PMD 306 to the second articulated seating system 103 as illustrated in FIG. 4B. The integrated platform 400 travels with the first articulated seating system 101, such that when the first articulated seating system 101 is deployed outside of the vehicle 380, persons with limited mobility can maneuver the PMD 306 to the integrated platform 400 and then transfer to the second articulated seating system 103. The first and second articulated seating systems 101 and 103 then travel back inside the vehicle 380 to the travel (home) or drive position.

The embodiment illustrated in FIGS. 4A-4B utilizes one seating system such as the second articulated seating system 103 to address mobility needs of an individual who occupies the seat of one seating system such as first articulated seating system 101 with the integrated platform 400 to stow an unoccupied personal mobility device or the PMD 306. In the embodiment that the first and the second articulated seating systems 101 and 103 are positioned on the same side of the vehicle 380, the arrangement allows for someone or a user to position the PMD 306 on the seating system that includes the integrated platform 400 to stow the PMD 306, and then the user transfers to the seating system designed to assist an individual with mobility such as the second articulated seating system 103.

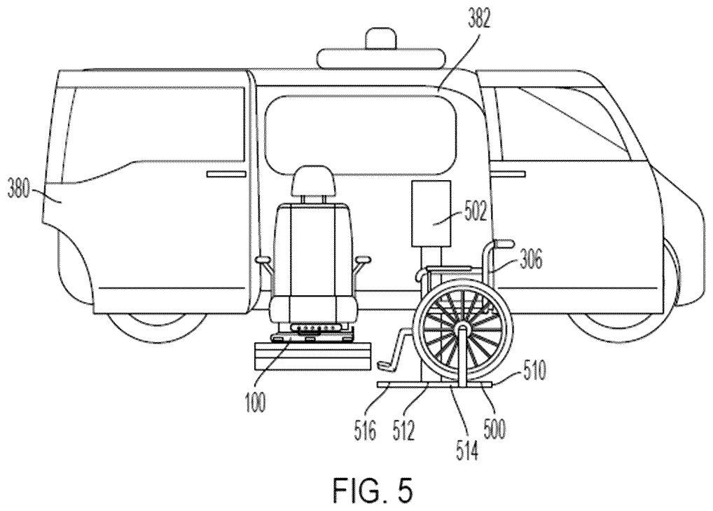

FIG. 5 illustrates one embodiment of a hoist platform 500 adjacent the articulated seating system 100 of FIG. 1G and a user seat mounted thereon. The hoist platform 500 is a standalone platform that is assembled with a lifting mechanism 502 wherein the lifting mechanism 502 works to move the hoist platform 500 from inside the vehicle 380 to outside the vehicle 380 to receive the PMD 306 and the operator thereof. The hoist platform 500 and the lifting mechanism 502 support and transport the PMD 306 and in some embodiments the occupant from outside to inside the vehicle 380. The hoist platform 500 is configured to stow the PMD 306 while the articulated seating system 100 is in its travel (home) position and the vehicle 380 is in motion. It is contemplated, however, that the hoist platform may instead be a hoist that lacks a platform and instead relies upon straps, hooks, clasps, claws, or other connecting members that receive and hold the PMD 306.

In the illustrated embodiment, the hoist platform 500 is a rectangular shape with a width and a length. In other embodiments, the hoist platform 500 is shaped differently such as square, semi-circular, trapezoidal, or some combination of these geometric shapes. The hoist platform 500 is made of a material that is strong enough and has a depth or thickness that is sufficient to hold the PMD 306 thereon.

The hoist platform 500 includes an extension end 510 opposite an attachment end 512 with a body portion 514 that spans between the extension and attachment ends 510 and 512, respectively. The extension end 510 includes the width that is sufficient to receive the PMD 306. The body portion 514 has a length and a width that are sufficient to receive the PMD 306. The body portion 514 includes a top surface 516 that is configured with one or more devices to receive, secure, and restrain the PMD 306 or other similar personal mobile devices in place while the vehicle 380 is in motion. For example, the one or more devices could include but is not limited to manual or automated securement such as securement straps, docking system for a wheelchair, bracket, hold down bar, wheel chocks, cargo barrier, fasteners, bolts, etc., that can be assembled on the body portion 514 to receive, secure, and restrain the PMD 306 in place while the vehicle 380 is in motion.

The attachment end 512 is configured for assembly with the lifting mechanism 502. The attachment end 512 can also be configured for assembly with other types of lifting mechanisms. In one embodiment, the attachment end 512 includes one or more openings sized to receive one or more fasteners for assembly with the lifting mechanism 502. In another embodiment, the attachment end 512 is welded to the lifting mechanism 502. In yet another embodiment, the attachment end 512 is assembled with the lifting mechanism 502 by one or more sliding mechanisms that allow interlocking between the attachment end 512 and one or more members of the lifting mechanism 502. In other embodiments, the attachment end 512 is assembled with the lifting mechanism 502 by other techniques.

The hoist platform 500 and the lifting mechanism 502 support and transport the PMD 306 from outside to inside the vehicle 380 and stows or stores the PMD 306 while the articulated seating system 100 or the seating system 100 are in its travel (home) or drive position and the vehicle 380 is in motion. The hoist platform 500 and the lifting mechanism 502 can be configured to travel with the articulated seating system 100, such that when the articulated seating system 100 is deployed outside of the vehicle 380, the hoist platform 500 is level on the ground in an access position allowing the PMD 306 to be maneuvered onto the hoist platform 500 and the occupant to transfer from the PMD 306 to the articulated seating system 100. Alternatively, the hoist platform 500 and the lifting mechanism 502 can be configured to travel independently of the articulated seating system 100, such that when the hoist platform 500 and the lifting mechanism 502 are deployed outside of the vehicle 380, persons with limited mobility can transfer to the hoist platform 500. Then the articulated seating system 100 can be deployed outside the vehicle 380 adjacent to the hoist platform 500 with the user and the PMD 306 already thereon, and independently or with help from an attendant, the user can maneuver from the PMD 306 to the user seat on the articulated seating system 100.

In one embodiment, the articulated seating system 100 with the user seat attached thereon is positioned in the vehicle 380 in the first row and the hoist platform 500 and the lifting mechanism 502 are positioned in the second row on the same side of the vehicle 380. In one embodiment, the vehicle 380 is an autonomous vehicle wherein the articulated seating system 100 and the hoist platform 500 attached to the lifting mechanism 502 are respectively positioned and attached in the first and second rows of the vehicle 380. In another embodiment, the articulated seating system 100 with the user seat are positioned in the vehicle 380 in the second row and the hoist platform 500 and the lifting mechanism 502 are positioned in the third row on the same side of the vehicle 380. In yet other embodiments, the articulated seating system 100 with the user seat attached thereon and the hoist platform 500 and the lifting mechanism 502 are positioned in the same row and adjacent to each other. In any of these embodiments, the vehicle 380 can be a van, an autonomous vehicle, or another type of vehicle configured to receive the articulated seating system 100, the user seat, the hoist platform 500, and the lifting mechanism 502 wherein the vehicle opening 382 is configured to receive the articulated seating system 100, the user seat, the hoist platform 500, and the lifting mechanism 502 there through. In other embodiments, the placement of the articulated seating system 100, the hoist platform 500 and the lifting mechanism 502 can be reversed in the vehicle 380.

In one method of operation, the articulated seating system 100 with the user seat attached thereon and the hoist platform 500 attached to the lifting mechanism 502 deploy next to each other either independently or together. The articulated seating system 100 with the user seat attached thereon and the hoist platform 500 attached to the lifting mechanism 502 are moved from a secured drive position (e.g., a standard interior vehicle seat position) to an extension position (wherein the articulated seating system 100 with the user seat attached thereon and the hoist platform 500 attached to the lifting mechanism 502 face out of the vehicle doorway or opening 382) and finally to an access position outside the vehicle 380 via the vehicle opening 382, facilitating access for a user in the PMD 306 onto the hoist platform 500. In one embodiment, the hoist platform 500 attached to the lifting mechanism 502 supports and transports the PMD 306 from outside to inside the vehicle 380. The occupant of the PMD 306 can transfer to the user seat associated with the articulated seating system 100 while the hoist platform 500 remains outside the vehicle 380. In one embodiment, the user in the user seat associated with the articulated seating system 100 and the hoist platform 500 attached to the lifting mechanism 502 move into the vehicle 380 via the door opening 382. In any of these embodiments, the lifting mechanism 502 is configured to move the hoist platform 502 from inside the vehicle 380 to outside the vehicle 380 and back inside the vehicle 380 through the door opening 382.

The hoist platform 500 stows or stores the PMD 306 while the articulated seating system 100 is in its travel (home) or drive position and the vehicle 380 is in motion. The hoist platform 500 travels with the lifting mechanism 502 and the articulated seating system 100, such that when the articulated seating system 100 is deployed outside of the vehicle 380, the hoist platform 500 is level on the ground in an access position allowing the PMD 306 to be maneuvered onto the hoist platform 500 and the occupant to transfer from the PMD 306 to the articulated seating system 100. The hoist platform 500 travels with the articulated seating system 100, such that when the articulated seating system 100 is deployed outside of the vehicle 380, persons with limited mobility can maneuver the PMD 306 to the hoist platform 500 and then transfer to the user seat of the articulated seating system 100. The user seat on the articulated seating system 100 then travel back inside the vehicle 380 to the travel (home) or drive position.

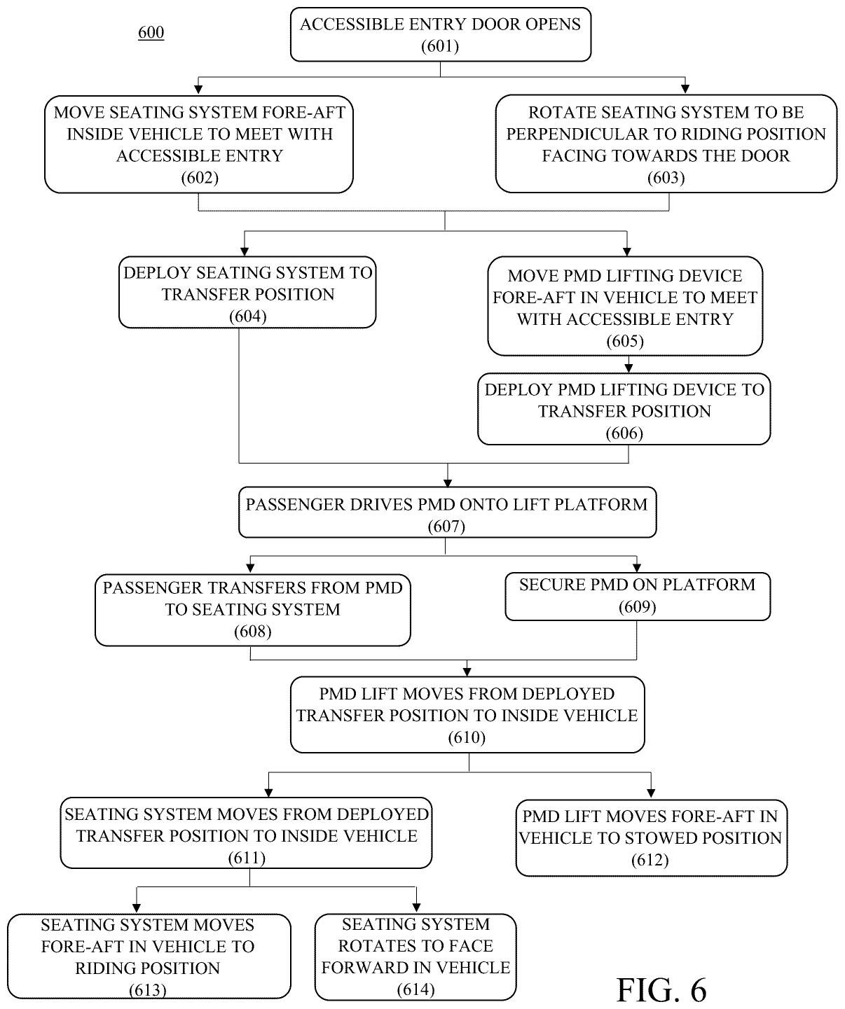

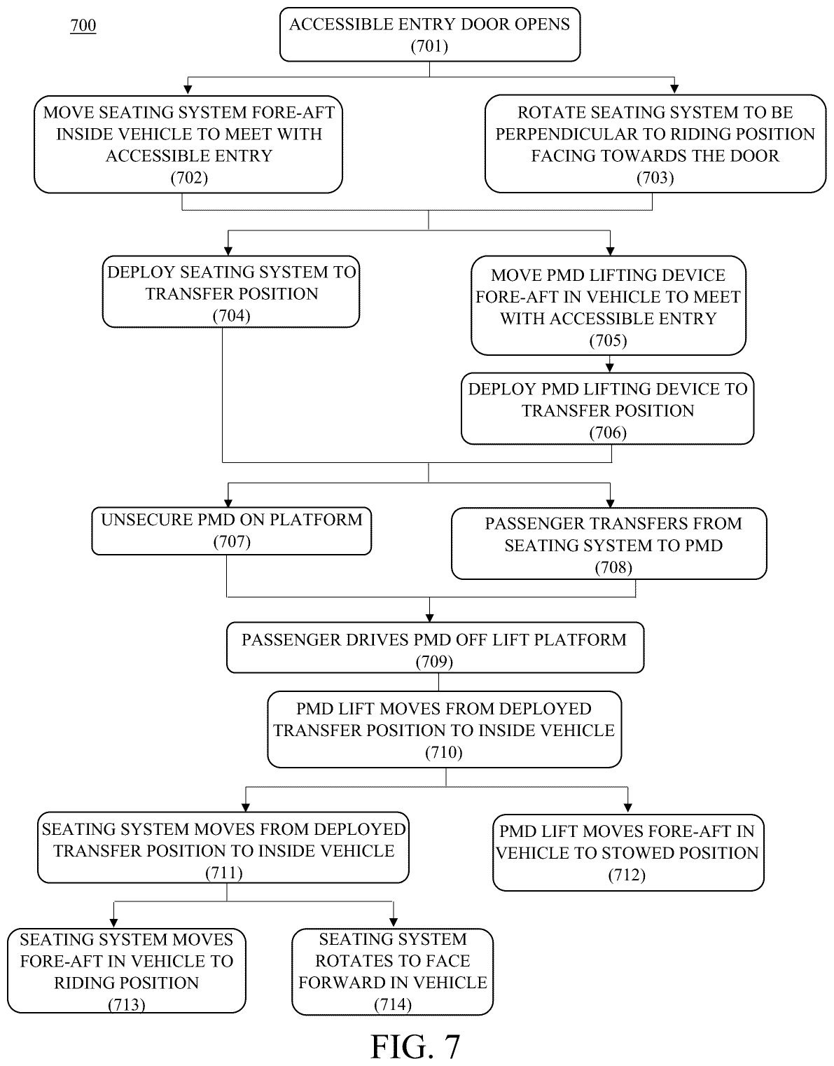

FIGS. 6 and 7 depict logic that may be used for automating or directing the sequence of ingress and egress of a passenger having mobility disabilities that is seated in a PMD. The logic of FIGS. 6 and 7 is relevant for any vehicle having two seating and or hoist/lift systems (such as those shown in FIGS. 4A, 4B, and 5) where the two systems are not able to pass through the door opening 382 at the same time. The logic may be especially relevant in autonomous vehicles where a vehicle operator or other attendant is not available to direct the operation of those systems.

The logic of FIGS. 6 and 7 may be implemented by a computing device configured to perform some or all of the processes and methods described below. The computing device may include a processor, storage, an input/output (I/O) interface, and a communications bus. The bus connects to and enables communication between the processor and the components of the computing device in accordance with known techniques. Note that in some computing devices there may be multiple processors incorporated therein, and in some systems there may be multiple computing devices. The processor 120 communicates with storage via the bus. Storage may include memory, such as Random Access Memory (RAM), Read Only Memory (ROM), flash memory, etc., which is directly accessible. Storage may also include a secondary storage device, such as a hard disk or disks (which may be internal or external), which is accessible with additional interface hardware and software as is known and customary in the art. Note that a computing device may have multiple memories (e.g., RAM and ROM), multiple secondary storage devices, and multiple removable storage devices (e.g., USB drive and optical drive). The computing device may also communicate with each of the articulating seating systems and PMD hoists/lifts, various sensors that detect the condition of the seating systems and hoists/lifts, various sensors that detect the position of the passenger and PMD within the vehicle (including their proximity and engagement with the articulating seating systems and hoists/lifts), other computing devices, computers, workstations, etc. or networks thereof through a communications adapter, wired or wireless. Note that the computing device may use multiple communication adapters for making the necessary communication connections. All these configurations, as well as the appropriate communications hardware and software, are known in the art. The computing device may be located onboard the articulating seating systems, the hoist/lift, or may be located remotely in the vehicle or elsewhere. The computing system may be configured to receive inputs from the passenger or other person, from a control panel in the vehicle, a personal computing device, such as a mobile phone having an appropriate application, or other remote computing device, for example at a vehicle dispatching site.

FIG. 6 demonstrates the logic 600 of sequencing the steps required for a passenger to enter the accessible vehicle 380 with a door opening 382 that is too narrow for the devices to pass through at the same time. The logic 600 is configured to coordinate movement of the seating system and lift system and prevent them from hitting each other (or the passenger or PMD) inside of the vehicle or while they pass through the door opening 382. First, in Step 601, the door of the accessible entry opens. The door may open based on an input (a door open signal or instruction) from the passenger or other person. Alternatively, the door may open based on input from a sensor or other device configured to detect the passenger or PMD at outside of the vehicle (such as a camera on the vehicle, a sensor on the vehicle configured to read an RFID tag associated with the passenger or PMD, etc). Alternatively, the door may also open based on dispatching information, for example, opening once the vehicle arrives at a pickup location and/or at an appropriate pickup time. In Step 602, the seating system 100 inside of the vehicle 380 moves fore-aft if necessary for alignment with the door opening 382. In Step 603, the seating system 100 rotates, in some cases 90 degrees, so that the seating system 100 is facing the door opening 382. Steps 602 and 603 may occur sequentially (602 then 603, or 603 then 602), simultaneously, or incrementally (e.g., slight fore-aft movement 602, then slight rotation 603, another slight fore-aft movement 602, etc.) until the seating system 100 is positioned inside the vehicle 380 ready to deploy. The sequencing of coordinating Steps 602-603 may depend on the interior layout of the vehicle 380 since the rotation and linear movement could cause the seating system 100, or passenger sitting in the seating system 100, to contact interior structures such as a door panel, dash board, or console. In some embodiments, Steps 602 and 603 may occur automatically and immediately after the door has opened. In some embodiments, Steps 602 and 603 may occur only after the computing system has detected (through sensors) or receives input indicative that an embarking passenger is seated in a PMD. Alternatively, Steps 602 and/or 603 may automatically occur after a door open input is received, but before the door opens, to block the door opening 382 and prevent amble passengers from entering the vehicle before the passenger seated in the PMD enters. Alternatively, where the computing system has access to dispatch data (i.e., pickup location and/or time), Steps 602 and/or 603 may automatically occur prior to the vehicle arriving at the pickup location and/or prior to the pickup time. Alternatively, Steps 602 and/or 603 may automatically occur while the door is in the process of opening to expedite the ingress process. In Step 604, the seating system is moved to the deployed position at least partially outside of the door opening 382. While the seating system 100 is deploying, in Step 605, the PMD hoist platform 500 (or other equipped lift device) may start moving fore-aft in the vehicle 380 so that it is aligned with the door opening 382. To the extent that the PMD hoist platform 500 (or other PMD lift system, such as platform 400 in FIGS. 4A and 4B) is configured to rotate, it may move fore-aft and rotate in a similar sequence and manner as described for seating system 100 above. In an alternative embodiment, Step 605 may start after the computing system receives feedback from sensors that Step 604 is complete. Subsequently, in Step 606 the hoist platform 500 deploys out of the door opening 382 and/or to the ground in the deployed position. Once the seating system 100 and hoist platform 500 are in the fully deployed position at rest, the systems are ready to accept the passenger. In an alternative embodiment, the platform 500 may deploy before the seating system 100. In such an embodiment, Steps 605, and 606 may be triggered in the same or similar manner as described above for Steps 602, 603, and 604. In Step 607, the passenger drives their PMD 306 onto the hoist platform 500 (or otherwise engages the PMD 306 with the lift system, which as discussed above can be of any type). In Step 608, the passenger then transfers from the PMD 306 to the seating system 100. In Step 609, the PMD 306 is secured to the hoist platform 500. This could be manually achieved by the passenger, or programed to occur automatically based on input from the passenger or sensor configured to detect when the PMD is positioned properly for engagement with the lift system. If autonomously securing, Step 609 could occur simultaneously to Step 608. If manually securing, Step 609 may occur before or after Step 608, depending on if the seating system 100 and hoist platform 500 are deployed close enough for the passenger to reach. In some cases, for example a manual wheelchair that is lightweight, the passenger may choose to transfer to the seating system 100 first, before collapsing, moving, or lifting the PMD into engagement with the lift system. Once the passenger is on the seating system 100 and the PMD 306 is secured on the hoist platform 500, in Step 610 the hoist platform 500 moves from the deployed position to inside the vehicle 380. Step 610 may be initiated in response to input from the passenger or other person. Alternatively, Step 610 may be initiated based on input from sensors that detect or confirm that the passenger is seated in the seating system 100 and the PMD is properly positioned and/or secured by the lift system. In Step 612, the hoist platform 500 moves fore-aft inside the vehicle 380 until reaching the stowed position. To the extent that the PMD hoist platform 500 (or other PMD lift system, such as platform 400 in FIGS. 4A and 4B) is configured to rotate, it may move fore-aft and rotate in a similar, but opposite sequence and manner (i.e., moving toward stowed position rather than toward the door opening 382) as described for seating system 100 above. In Step 611, the seating system 100 moves from the deployed position to inside the vehicle 380. In one embodiment, Step 611 is initiated after receiving feedback from sensors that Step 610 or 612 is complete. Alternatively Step 611 may initiate movement of seating system 100 while Step 612 is still operating the hoist platform 500. In Step 613, the seating system 100 moves fore-aft inside the vehicle 380. In Step 614, the seating system 100 rotates, for example 90 degrees, to face the intended direction for transit (typically forward or rearward) in the vehicle 380. Similar to Steps 602-603, Steps 613-614 may occur sequentially (613 then 614, or 614 then 613), simultaneously, or incrementally (slight fore-aft movement 613, then slight rotation 614, etc.) until the seating system 100 is positioned inside the vehicle 380 in the riding position. In an alternative embodiment, the seating system may move inside the vehicle before the lift system. In such an embodiment, Steps 611, 613, 614 may be triggered in the same or similar manner as described above for Steps 610, 612. Although not shown in FIG. 6, once the computing system receives an input that the seating system and lift device are in the appropriate position for transit (e.g., a door close input from the passenger or feedback from a sensor), the door may automatically close.

FIG. 7 demonstrates the logic 700 of sequencing the steps required for a passenger to exit the accessible vehicle 380 with a door opening 382 that is too narrow for the devices to pass through at the same time. The logic 700 is configured to coordinate movement of the seating system and lift system and prevent them from hitting each other (or the passenger or PMD) inside of the vehicle or while they pass through the door opening 382. First, in Step 701 the door of the accessible entry opens. The door may open based on an input (a door open signal or instruction) from the passenger or other person. Alternatively, the door may also open based on dispatching information, for example, opening once the vehicle arrives at a dropoff location and/or at an appropriate dropoff time. In Step 702, the seating system inside the vehicle 380 moves fore-aft if necessary for alignment with the door opening 382. In Step 703, the seating system 100 rotates, in some cases 90 degrees, so that the seating system 100 is facing the door opening 382. Steps 702 and 703 may occur sequentially (702 then 703, or 703 then 702), simultaneously, or incrementally (e.g., slight fore-aft movement 702, then slight rotation 703, another slight fore-aft movement 702, etc.) until the seating system 100 is positioned inside the vehicle 380 ready to deploy. The sequencing of coordinating Steps 602-603 may depend on the interior layout of the vehicle 380 since the rotation and linear movement could cause the seating system 100, or passenger sitting in the seating system 100, to contact interior structures such as a door panel, dashboard, or console. In some embodiments, Steps 702 and 703 may occur automatically and immediately after the door has opened. In some embodiments, Steps 702 and 703 may occur only after the computing system has detected (through sensors) or receives input indicative that an disembarking passenger needs to be reseated in a PMD. Alternatively, Steps 702 and/or 703 may automatically occur after a door open input is received, but before the door opens, to block the door opening 382 and prevent amble passengers from entering the vehicle before the passenger seated in the PMD exits. Alternatively, where the computing system has access to dispatch data (i.e., pickup location and/or time), Steps 702 and/or 703 may automatically occur prior to the vehicle arriving at the dropoff location and/or prior to the dropoff time. Alternatively, Steps 702 and/or 703 may automatically occur while the door is in the process of opening to expedite the egress process. In Step 704, the seating system 100 moves to the deployed position at least partially outside of the door opening 382. While the seating system 100 is deploying, in Step 705 the PMD hoist platform 500 (or other equipped lift device) may start moving fore-aft in the vehicle 380 so that it is aligned with the door opening 382. To the extent that the PMD hoist platform 500 (or other PMD lift system, such as platform 400 in FIGS. 4A and 4B) is configured to rotate, it may move fore-aft and rotate in a similar sequence and manner as described for seating system 100 above. In an alternative embodiment, Step 705 may start after the computing system receives feedback from sensors that Step 704 is complete. Subsequently, in Step 706 the hoist platform 500 deploys out the door opening 382 and/or to the ground in the deployed position. In an alternative embodiment, the platform 500 may deploy before the seating system 100. In such an embodiment, Steps 705, and 706 may be triggered in the same or similar manner as described above for Steps 702, 703, and 704. Once the seating system 100 and hoist platform 500 are in the fully deployed position at rest, the passenger may transfer from the seating system 100 to the PMD 306. In Step 707, the PMD 306 is unsecured from the hoist platform 500. This could be manually achieved by the passenger, or programed to occur automatically based on input from the passenger or sensor configured to detect when the passenger has transferred from the seat and/or to the PMD. If autonomously unsecuring, Step 707 could occur simultaneously to Step 708. If manually unsecuring, Step 707 may occur before or after Step 708, depending on if the seating system 100 and hoist platform 500 are deployed close enough for the passenger to reach. Then in Step 709, the passenger may drive the PMD 306 off of the hoist platform 500. In some cases, for example a manual wheelchair that is lightweight, the passenger may choose to not only unsecure the PMD but also remove the PMD from the lift device before transferring. In such a case, there would be no need to “drive off” the lift device. Once the passenger in the PMD 306 is clear of the hoist platform 500, in Step 710 the hoist platform 500 moves from the deployed position to inside the vehicle 380. Step 710 may be initiated based on input from the passenger or another person. Alternatively, Step 710 may be initiated automatically based on input from sensors that detect the passenger's and PMD's departures from the seating system and lift device. In Step 712, the hoist platform 500 moves fore-aft inside the vehicle 380 until reaching the stowed position. To the extent that the PMD hoist platform 500 (or other PMD lift system, such as platform 400 in FIGS. 4A and 4B) is configured to rotate, it may move fore-aft and rotate in a similar, but opposite sequence and manner (i.e., moving toward stowed position rather than toward the door opening 382) as described for seating system 100 above. In Step 711, the seating system 100 moves from the deployed position to inside the vehicle 380. In one embodiment, Step 711 is initiated after receiving feedback from sensors that Step 710 or 712 is complete. Alternatively, Step 711 may initiate movement of seating system 100 while Step 712 is still operating the hoist platform 500. In Step 713, the seating system 100 moves fore-aft inside the vehicle 380. In Step 714, seating system 100 rotates, for example, 90 degrees, to face the intended direction for transit (typically forward or rearward) in the vehicle 380. Similar to Steps 702-703, Steps 713-714 may occur sequentially (713 then 714, or 714 then 713), simultaneously, or incrementally (slight fore-aft movement 713, then slight rotation 714, etc.) until the seating system 100 is positioned inside the vehicle 380 in the riding position. In an alternative embodiment, the seating system may move inside the vehicle before the lift system. In such an embodiment, Steps 711, 713, 714 may be triggered in the same or similar manner as described above for Steps 710, 712. Although not shown in FIG. 6, once the computing system receives an input that the seating system and lift device are in the appropriate position for transit (e.g., a door close input from the passenger or feedback from a sensor), the door may automatically close.

Additional steps to the logic 600 and 700 demonstrated in FIGS. 6-7 are considered. For example, The passenger may need to set the brake on the PMD 306 when it is positioned on the hoist platform 500, and undo the brake on the PMD 306 before driving it off the hoist platform 500. If the PMD 306 is powered, the passenger may turn off the PMD when it is positioned on the hoist platform 500, and turn it back on before driving off the hoist platform 500. After transitioning onto the seating system 100 but before the seating system 100 moves from deployed position (between Steps 608 and 611), the passenger must secure themselves using the buckles provided on the seating system 100. Conversely, after the seating system 100 is deployed but before the passenger transfers to the PMD 306 (between Steps 704-708), the passenger must unfasten buckles on the seating system 100. Operation of the seating system and lift systems may be interlocked to sensors operatively connected to the passenger belts and PMD securement. In other words, operation of the seating system and/or lift system may be prevented (or stopped) if the passenger and/or PMD are not secure. Similarly, operating of the vehicle may be prevented (or stopped) if the passenger and/or PMD are not secure.

During any of the operations or steps described above, the computing system may be configured to monitor input from sensors for obstructions or other errors, to halt the operation, and provide an aural or visible alert (sound, light) of the error. The computing system may additionally alert an autonomous vehicle dispatcher who may assist the passenger as needed.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An accessible vehicle having a door opening with a door comprising:
a lifting device having a PMD receiving portion configured to receive a PMD, the PMD receiving portion being movable from a stow position at an interior of the vehicle through the door opening to a deployed position at an exterior of the vehicle;
a seating system with a passenger seat, the passenger seat being moveable from a stow position at an interior of the vehicle through the door opening to a deployed position at the exterior of the vehicle;
wherein the passenger seat in the deployed position is disposed adjacent the PMD receiving portion in the deployed position whereby a passenger may transfer from the PMD to the passenger seat.

2. The accessible vehicle of claim 1 having a computing system configured to sequence the operation of the lifting device and the operation of the seating system to prevent the passenger seat from hitting the PMD receiving portion when deploying the PMD receiving portion and the passenger seat at a pickup location.

3. The accessible vehicle of claim 2, wherein the computing system is configured to move a first of the PMD receiving portion and the passenger seat from the stow position toward the deployed position before moving a second of the PMD receiving portion and the lifting device from the stow position toward the deployed position.

4. The accessible vehicle of claim 3, wherein the computing system is configured to stage the first of the PMD receiving portion and the passenger seat adjacent the door opening prior to opening the door at the pickup location.

5. The accessible vehicle of claim 3, wherein the computing system is configured to begin moving the second of the PMD receiving portion and the passenger seat from the stow position toward the deployed position before the first of the PMD receiving portion and the passenger seat has reached the deployed position.

6. The accessible vehicle of claim 3, wherein the computing system is configured to begin moving the second of the PMD receiving portion and the passenger seat from the stow position toward the deployed position after the first of the PMD receiving portion and the passenger seat has reached the deployed position.

7. The accessible vehicle of claim 3, wherein the computing system is configured to begin moving one of the first and the second of the PMD receiving portion and the passenger seat from the deployed position toward the stow position after detecting that the passenger has transferred from the PMD to the passenger seat.

8. The accessible vehicle of claim 7, wherein the computing system is configured to begin moving an other of the first and the second of the PMD receiving portion and the passenger seat from the deployed position toward the stow position before the one of the first and the second of the PMD receiving portion and the passenger seat reaches the stow position.

9. The accessible vehicle of claim 7, wherein the computing system is configured to begin moving an other of the first and the second of the PMD receiving portion and the passenger seat from the deployed position toward the stow position after the one of the first and the second of the PMD receiving portion and the passenger seat reaches the stow position.

10. The accessible vehicle of claim 1 having a computing system configured to sequence the operation of the lifting device and the operation of the seating system to prevent the passenger and the passenger seat from hitting the PMD and the PMD receiving portion when deploying the PMD receiving portion and the passenger seat at a dropoff location.

11. The accessible vehicle of claim 10, wherein the computing system is configured to move a first of the PMD receiving portion and the passenger seat from the stow position toward the deployed position before moving a second of the PMD receiving portion and the lifting device from the stow position toward the deployed position.

12. The accessible vehicle of claim 11, wherein the computing system is configured to stage the first of the PMD receiving portion and the passenger seat adjacent the door opening prior to opening the door at the dropoff location.

13. The accessible vehicle of claim 11, wherein the computing system is configured to begin moving the second of the PMD receiving portion and the passenger seat from the stow position toward the deployed position before the first of the PMD receiving portion and the passenger seat has reached the deployed position.

14. The accessible vehicle of claim 11, wherein the computing system is configured to begin moving the second of the PMD receiving portion and the passenger seat from the stow position toward the deployed position after the first of the PMD receiving portion and the passenger seat has reached the deployed position.

15. The accessible vehicle of claim 10, wherein the computing system is configured to begin moving the passenger seat from the deployed position toward the stow position only after detecting that the passenger has transferred from the passenger seat to the PMD.

16. The accessible vehicle of claim 10, wherein the computing system is configured to begin moving the PMD receiving portion from the deployed position toward the stow position only after detecting that the PMD has been disengaged from the PMD receiving portion.

17. The accessible vehicle of claim 10, wherein the computing system is configured to begin moving one of the first and the second of the PMD receiving portion and the passenger seat from the deployed position toward the stow position before moving an other of the first and the second of the PMD receiving portion and the passenger seat from the deployed position toward the stow position.

18. The accessible vehicle of claim 17, wherein the computing system is configured to begin moving the other of the first and the second of the PMD receiving portion and the passenger seat from the deployed position toward the stow position before the one of the first and the second of the PMD receiving portion and the passenger seat reaches the stow position.

19. The accessible vehicle of claim 17, wherein the computing system is configured to begin moving an other of the first and the second of the PMD receiving portion and the passenger seat from the deployed position toward the stow position after the one of the first and the second of the PMD receiving portion and the passenger seat reaches the stow position.
